(19) United States
(12) Patent Application Publication
(10) Pub. No.: US 2025/0238687 A1
(43) Pub. Date: Jul. 24, 2025

(54) SYSTEMS AND METHODS FOR PREDICTIVE LAYER PROVISIONING

(71) Applicant: Dell Products L.P., Round Rock, TX (US)

(72) Inventors: Ryan N. COMER, Round Rock, TX (US); Fabricio C. DUARTE, Stanwood, WA (US); Uboho VICTOR, San Antonio, TX (US); Jake M. LELAND, Round Rock, TX (US)

(73) Assignee: Dell Products L.P., Round Rock, TX (US)

(21) Appl. No.: 18/419,950

(22) Filed: Jan. 23, 2024

(51) Int. Cl. G06N 5/022

(52) U.S. Cl. CPC G06N 5/022

(57) ABSTRACT

An information handling system may include a processor and a predictive orchestrator comprising a program of instructions configured to, when read and executed by the processor, in a distributed ecosystem comprising a plurality of host systems, determine a probability of an image layer executing on a host system of the plurality of host systems and cause the image layer to be pre-loaded on the host system if the probability of the image layer executing on the host system satisfies a threshold probability.

### TECHNICAL FIELD

The present disclosure relates in general to information handling systems, and more particularly to methods and systems for predictive layer provisioning in a distributed system of information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In a distributed computing system, the ecosystem may have a plurality of distributed computing endpoints, each endpoint capable of instantiating containers for executing workloads. Containerization is an increasingly popular method of packaging and distributing software, with benefits in security, portability, and scalability. Workloads running in containers may be easily moved, or “offloaded,” to machines better suited for the task.

In a distributed computing system, containers may be used to distribute workloads among various virtual or physical machines at a user's disposal. These workloads are often containerized workloads, and containerized workloads are often composed of image layers that are used to build the container image.

When a containerized workload is instantiated on an endpoint, the layers that make up the container image need to be downloaded and stored at the endpoint, which uses network and disk resources. If the layers for a container workload are not already present on an endpoint, then a new workload launch will be a “cold start” and will require downloading all the layers required for the container image. This may require significant time for the new workload to start on the endpoint, which creates a negative user experience.

### SUMMARY

In accordance with the teachings of the present disclosure, the disadvantages and problems associated with existing approaches to containerized workload execution May be reduced or eliminated.

In accordance with embodiments of the present disclosure, an information handling system may include a processor and a predictive orchestrator comprising a program of instructions configured to, when read and executed by the processor, in a distributed ecosystem comprising a plurality of host systems, determine a probability of an image layer executing on a host system of the plurality of host systems and cause the image layer to be pre-loaded on the host system if the probability of the image layer executing on the host system satisfies a threshold probability.

In accordance with these and other embodiments of the present disclosure, a method may include, in a distributed ecosystem comprising a plurality of host systems, determining a probability of an image layer executing on a host system of the plurality of host systems and causing the image layer to be pre-loaded on the host system if the probability of the image layer executing on the host system satisfies a threshold probability.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to, in a distributed ecosystem comprising a plurality of host systems, determine a probability of an image layer executing on a host system of the plurality of host systems and cause the image layer to be pre-loaded on the host system if the probability of the image layer executing on the host system satisfies a threshold probability.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example distributed ecosystem, in accordance with embodiments of the present disclosure; and

FIG. 2 illustrates a block diagram demonstrating an example method for predictive layer provisioning, in accordance with embodiments of the present disclosure.

### DETAILED DESCRIPTION

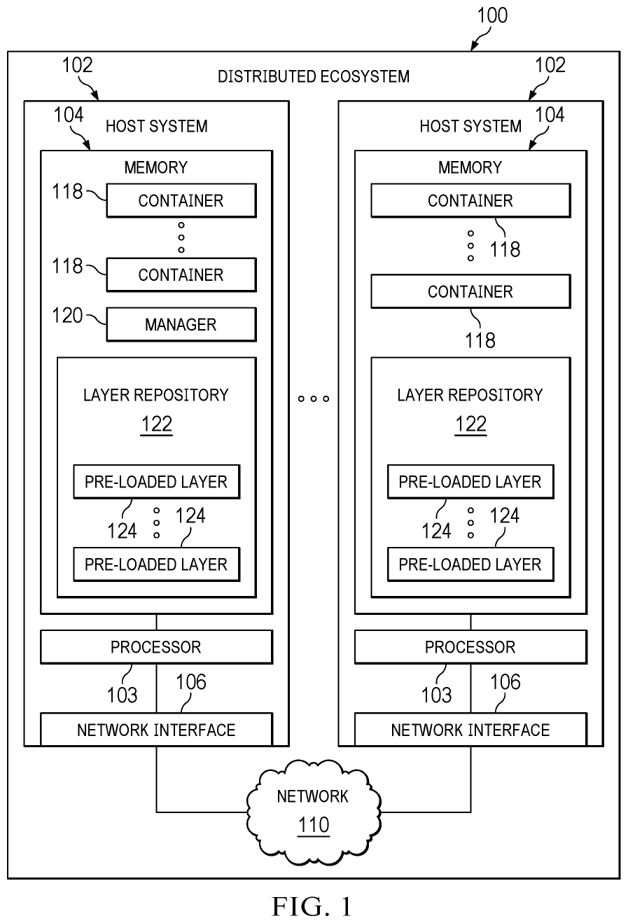

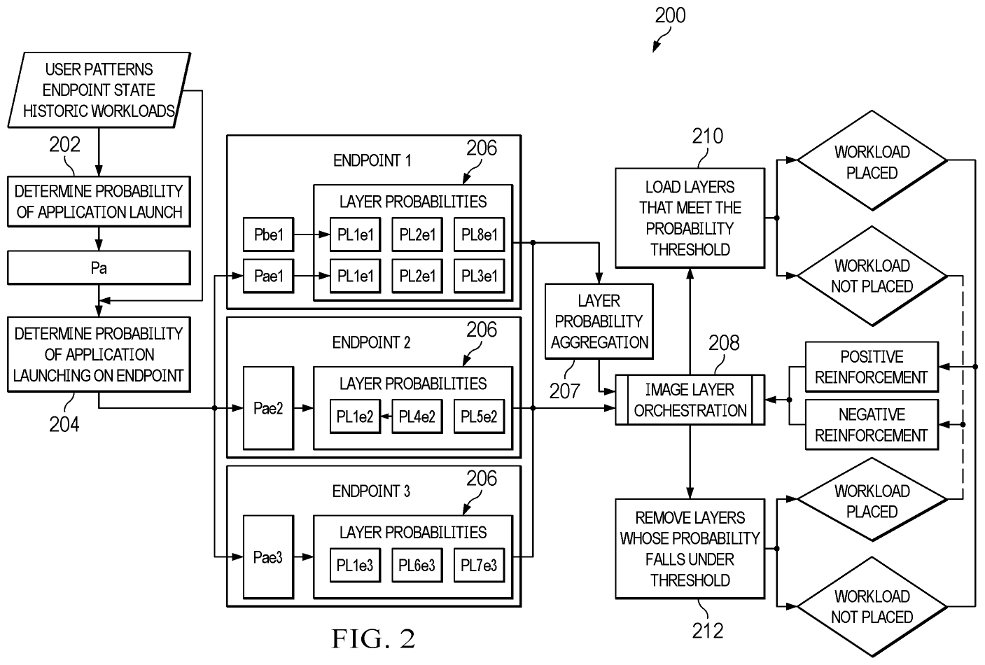

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of selected components of an example distributed ecosystem 100 having a plurality of host systems 102, in accordance with embodiments of the present disclosure. As shown in FIG. 1, distributed ecosystem 100 may include a plurality of host systems 102 coupled to one another via a network 110. In some embodiments, two or more of the plurality of host systems 102 may be co-located in the same geographic location (e.g., building or data center). In these and other embodiments, two or more of the plurality of host systems 102 may be co-located in the enclosure, rack, or chassis. In these and other embodiments, two or more of the plurality of host systems 102 may be located in substantially different geographic locations.

A host system 102 may comprise an information handling system. In some embodiments, a host system 102 may comprise a server (e.g., embodied in a “sled” form factor). In these and other embodiments, a host system 102 may comprise a personal computer. In other embodiments, a host system 102 may be a portable computing device (e.g., a laptop, notebook, tablet, handheld, smart phone, personal digital assistant, etc.). As depicted in FIG. 1, host system 102 may include a processor 103, a memory 104 communicatively coupled to processor 103, and a network interface 106 communicatively coupled to processor 103. For the purposes of clarity and exposition, in FIG. 1, each host system 102 is shown as comprising only a single processor 103, single memory 104, and single network interface 106. However, a host system 102 may comprise any suitable number of processors 103, memories 104, and network interfaces 106.

A processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in a memory 104 and/or other computer-readable media accessible to processor 103.

A memory 104 may be communicatively coupled to a processor 103 and may include any system, device, or apparatus configured to retain program instructions and/or data for a period of time (e.g., computer-readable media). A memory 104 may include RAM, EEPROM, a PCMCIA card, flash memory, magnetic storage, opto-magnetic storage, or any suitable selection and/or array of volatile or non-volatile memory that retains data after power to host system 102 is turned off.

As shown in FIG. 1, a memory 104 may have stored thereon one or more containers 118. In some embodiments, one or more of containers 118 may be stored in a computer-readable medium (e.g., a local or remote hard disk drive) other than a memory 104 which is accessible to processor 103.

A container 118 or containerized application may include instructions for a container runtime to virtualize a computer's operating system kernel, enabling users to install containers (e.g., isolated application environments) on a virtualized operating system. Containerized applications may be built based on a containerfile, which is an ordered list of instructions on how to set up an environment and install an application. Each command in such ordered list may become a subsequent layer in the final container image. Often, the first few instructions in this containerfile will install libraries that the application needs to run, forming layers that are effectively “independent” and thus good candidates for sharing across other container images.

At least one host system 102 in distributed ecosystem 100 may have stored within its memory 104 a manager 120. A manager 120 may comprise software and/or firmware generally operable to manage containers 118 instantiated on host system 102, including controlling migration of containers 118 between host systems 102. Further, as described in greater detail below, a manager 120 may perform orchestration of workloads and image layers among various host systems 104/endpoints of distributed ecosystem 100, including predictive provisioning of layers onto endpoints.

As shown in FIG. 1, each memory 104 may also include a layer repository 122. Layer repository 122 may include a repository of pre-loaded layers 124. In operation, as described in greater detail below, manager 120 may predictively orchestrate placement of pre-loaded layers 124 onto endpoints, for example based on a probability that a container requiring one or more layers may be instantiated on a particular endpoint.

A network interface 106 may include any suitable system, apparatus, or device operable to serve as an interface between an associated host system 102 and network 110. A network interface 106 may enable its associated host system 102 to communicate with network 110 using any suitable transmission protocol (e.g., TCP/IP) and/or standard (e.g., IEEE 802.11, Wi-Fi). In certain embodiments, a network interface 106 may include a physical NIC. In the same or alternative embodiments, a network interface 106 may be configured to communicate via wireless transmissions. In the same or alternative embodiments, a network interface 106 may provide physical access to a networking medium and/or provide a low-level addressing system (e.g., through the use of Media Access Control addresses). In some embodiments, a network interface 106 may be implemented as a local area network (“LAN”) on motherboard (“LOM”) interface. A network interface 106 may comprise one or more suitable network interface cards, including without limitation, mezzanine cards, network daughter cards, etc.

Network 110 may be a network and/or fabric configured to communicatively couple information handling systems to each other. In certain embodiments, network 110 may include a communication infrastructure, which provides physical connections, and a management layer, which organizes the physical connections of host systems 102 and other devices coupled to network 110. Network 110 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 110 may transmit data using any storage and/or communication protocol, including without limitation, Fibre Channel, Fibre Channel over Ethernet (FCOE), Small Computer System Interface (SCSI), Internet SCSI (iSCSI), Frame Relay, Ethernet Asynchronous Transfer Mode (ATM), Internet protocol (IP), or other packet-based protocol, and/or any combination thereof. Network 110 and its various components may be implemented using hardware, software, or any combination thereof.

In addition to processor 103, memory 104, and network interface 106, a host system 102 may include one or more other information handling resources.

FIG. 2 illustrates a block diagram demonstrating an example method 200 for predictive layer provisioning, in accordance with embodiments of the present disclosure. According to some embodiments, method 200 may begin at step 202 and may be implemented in a variety of configurations of distributed ecosystem 100. As such, the preferred initialization point for method 200 and the order of the steps comprising method 200 may depend on the implementation chosen.

At step 202, manager 120 may determine the probability Pa of an application launching based on one or more predictive parameters. For example, the probability of an application launching may be based on the state of an endpoint (e.g., the presence, availability, and/or and usage of processing, memory, and/or other hardware resources of the endpoint), historic workload placement (e.g., identity of endpoints in which particular workloads have been placed in the past and/or the context in which they were placed), and/or user actions (e.g., the various actions users are taking in distributed ecosystem 100).

At step 204, based on the probability Pa and the one or more predictive parameters, manager 120 may determine, for one or more endpoints, a probability of the application launching on each of the endpoints. For example, as shown in FIG. 2, manager 120 may calculate a probability Pae1 of the application executing on an endpoint 1, a probability Pae2 of the application executing on an endpoint 2, and a probability Pae3 of the application executing on an endpoint 3.

At step 206, for each endpoint, based on the probability that the application will launch on such endpoint, manager 120 may determine, based on the image layers that make up a container for executing the workload, a probability that the various layers will be required on the endpoint. For example, with respect to the application, manager 120 may determine a probability PL1e1 that a first layer will execute on endpoint 1, a probability PL2e1 that a second layer will execute on endpoint 1, and a probability PL3e1 that a third layer will execute on endpoint 1. Manager 120 may determine analogous layer probabilities for layers on other endpoints as well.

Further, manager 120 may perform steps 202-206 for multiple workloads. Thus, as shown in FIG. 2, in addition to determining layer probabilities PL1e1, PL2e1, and PL3e1 associated with the probability Pae1 of the application executing on endpoint 1, manager 120 may also determine layer probabilities (e.g., PL1e1, PL2e2, PL8e1) associated with the probability Pbe1 of a second application executing on endpoint 1. Although not shown in FIG. 2 for purposes of clarity and exposition, manager 120 may determine layer probabilities associated with the probability of other applications executing any or all of endpoints 1, 2, and 3. Further, a distributed ecosystem 100 is not limited to three endpoints.

In some instances, a particular layer may be integral to multiple container workloads that have a probability of executing on an endpoint. For example, as shown in FIG. 2, a first layer may have multiple probabilities PL1e1 of executing on endpoint 1—each probability associated with a different application, and a second layer may have multiple probabilities PL2e1 of executing on endpoint 1—each probability associated with a different application. In such a situation, as shown at step 207, manager 120 may perform a calculation to determine a cumulative probability for the layer executing on the endpoint based on the individual probabilities associated with each application having a probability of executing on the endpoint. As a particular example, if a layer has a first probability P(A) of executing on an endpoint in connection with a first application, and the layer has a second probability P(B) of executing on the endpoint in connection with a second application, then manager 120 may use basic principles of probability and statistics to determine that the probability of the layer executing on the endpoint is P(A)+P(B)−P(A)·P(B).

At step 208, manager 120 may perform image layer orchestration with respect to the various layers based on probabilities of the layer's execution on the various endpoints. For example, at step 210, for each layer that meets or exceeds a particular threshold for execution on a particular endpoint, manager 110 may cause such layer to be loaded upon such endpoint as a pre-loaded layer 124 (assuming such layer is not already pre-loaded), such that the layer may not require download when a workload requiring the layer is later placed on such endpoint. As another example, at step 212, for each layer that fails to satisfy a particular threshold for execution on a particular endpoint, manager 120 may cause such layer to, if already loaded as a pre-loaded layer 124 on such endpoint, be removed from such endpoint, thus saving storage capacity on such endpoint.

In some embodiments, manager 120 may also implement artificial intelligence and/or machine learning to refine its predictive capabilities. For example, if a layer is pre-loaded on an endpoint, positive reinforcement or negative reinforcement may be applied (e.g., by modifying associated probability metrics for the layer and/or endpoint) based on a frequency of workloads executing on the endpoint that utilize the layer. Similarly, if a layer is not pre-loaded on an endpoint, positive reinforcement or negative reinforcement may also be applied (e.g., by modifying associated probability metrics for the layer and/or endpoint) based on a frequency of workloads executing on the endpoint that need to download the layer for execution.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented using distributed ecosystem 100 or any other system operable to implement method 200. In certain embodiments, method 200 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a processor; and
a predictive orchestrator comprising a program of instructions configured to, when read and executed by the processor, in a distributed ecosystem comprising a plurality of host systems:
determine a probability of an image layer executing on a host system of the plurality of host systems; and
cause the image layer to be pre-loaded on the host system if the probability of the image layer executing on the host system satisfies a threshold probability.

2. The information handling system of claim 1, the predictive orchestrator further configured to cause the image layer to be removed from the host system if the layer is already pre-loaded on the host system and the probability of the image layer executing on the host system fails to satisfy the threshold probability.

3. The information handling system of claim 1, wherein determining the probability of the image layer executing on the host system comprises determining a probability of a workload requiring the image layer executing on the host system.

4. The information handling system of claim 3, wherein the probability of the workload executing on the host system is based on one or more predictive parameters comprising one or more of a state of the host system, historic workload placement of the workload, and user actions associated with the workload.

5. The information handling system of claim 1, wherein the probability of the image layer executing on the host system is based on one or more predictive parameters comprising one or more of a state of the host system, historic workload placement of one or more workloads requiring execution of the image layer, and user actions associated with the one or more workloads requiring execution of the image layer.

6. The information handling system of claim 1, wherein determining the probability of the image layer executing on the host system comprises determining at least two probabilities comprising:
a probability of a first workload requiring the image layer executing on the host system; and
a probability of a second workload requiring the image layer executing on the host system.

7. A method comprising, in a distributed ecosystem comprising a plurality of host systems:
determining a probability of an image layer executing on a host system of the plurality of host systems; and
causing the image layer to be pre-loaded on the host system if the probability of the image layer executing on the host system satisfies a threshold probability.

8. The method of claim 7, the predictive orchestrator further configured to cause the image layer to be removed from the host system if the layer is already pre-loaded on the host system and the probability of the image layer executing on the host system fails to satisfy the threshold probability.

9. The method of claim 7, wherein determining the probability of the image layer executing on the host system comprises determining a probability of a workload requiring the image layer executing on the host system.

10. The method of claim 9, wherein the probability of the workload executing on the host system is based on one or more predictive parameters comprising one or more of a state of the host system, historic workload placement of the workload, and user actions associated with the workload.

11. The method of claim 7, wherein the probability of the image layer executing on the host system is based on one or more predictive parameters comprising one or more of a state of the host system, historic workload placement of one or more workloads requiring execution of the image layer, and user actions associated with the one or more workloads requiring execution of the image layer.

12. The method of claim 7, wherein determining the probability of the image layer executing on the host system comprises determining at least two probabilities comprising:
a probability of a first workload requiring the image layer executing on the host system; and
a probability of a second workload requiring the image layer executing on the host system.

13. An article of manufacture comprising:
a non-transitory computer-readable medium; and
computer-executable instructions carried on the computer-readable medium, the instructions readable by a processor, the instructions, when read and executed, for causing the processor to, in a distributed ecosystem comprising a plurality of host systems:
determine a probability of an image layer executing on a host system of the plurality of host systems; and 10
cause the image layer to be pre-loaded on the host system if the probability of the image layer executing on the host system satisfies a threshold probability.

13. he article of claim 13, the processor further configured to cause the image layer to be removed from the host system if the layer is already pre-loaded on the host system and the probability of the image layer executing on the host system fails to satisfy the threshold probability.

15. The article of claim 13, wherein determining the probability of the image layer executing on the host system comprises determining a probability of a workload requiring the image layer executing on the host system.

16. The article of claim 15, wherein the probability of the workload executing on the host system is based on one or more predictive parameters comprising one or more of a state of the host system, historic workload placement of the workload, and user actions associated with the workload.

17. The article of claim 15, wherein the probability of the image layer executing on the host system is based on one or more predictive parameters comprising one or more of a state of the host system, historic workload placement of one or more workloads requiring execution of the image layer, and user actions associated with the one or more workloads requiring execution of the image layer.

18. The article of claim 15, wherein determining the probability of the image layer executing on the host system comprises determining at least two probabilities comprising:
a probability of a first workload requiring the image layer executing on the host system; and
a probability of a second workload requiring the image layer executing on the host system.
